(19) United States
(12) Patent Application Publication
(10) Pub. No.: US 2010/0158480 A1
(43) Pub. Date: Jun. 24, 2010

(54) MULTI-STREAM ENCRYPTION METHOD AND APPARATUS, AND HOST DEVICE FOR MULTI-CHANNEL RECORDING

(76) Inventors: Joon Young JUNG, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/548,805

(22) Filed: Aug. 27, 2009

(30) Foreign Application Priority Data
Dec. 22, 2008 (KR) 10-2008-0130894

(51) Int. Cl. H04N 5/91

(52) U.S. Cl. 386/94; 386/E05.004

(57) ABSTRACT

A multi-stream encryption apparatus and method, and a host device for multi-channel recording of a plurality of fee-based broadcasting services in a Downloadable Conditional Access System (DCAS) are provided.

### CROSS-REFERENCE TO RELATED APPLICATION

This application claims priority from Korean Patent Application No. 10-2008-0130894, filed on Dec. 22, 2008, in the Korean Intellectual Property Office, the entire disclosure of which is incorporated herein by reference.

### BACKGROUND OF THE INVENTION

1. Field of the Invention

The present invention relates to a multi-stream encryption method and apparatus, and a host device in a cable broadcasting system, and more particularly, to a multi-stream encryption method and apparatus and a host device in a Downloadable Conditional Access System (DCAS) for multi-channel recording of a plurality of fee-based channels.

2. Description of Related Art

A Conditional Access System (CAS) may enable only authorized subscribers to watch a fee-based program using a code of a broadcasting program. Currently, a digital cable broadcasting system generally uses a cable card such as a Personal Computer Memory Card International Association (PCMCIA) or a smart card depending on an application of a Conditional Access (CA) technology, to provide a fee-based broadcasting service. In a conventional art, however, a CAS software (or CAS client image) may be distributed off-line through a smart card or a PCMCIA card. Accordingly, when a problem occurs in a CAS, a predetermined time may be spent in reissuing a card, and an additional cost may be required due to the reissuance of the card.

Currently, a Downloadable Conditional Access System (DCAS) based on an interactive cable network is developed to overcome such disadvantages. In DCAS, a security module where a CAS software is installed may be mounted in a set-top box, and a security module program including the CAS software may be easily updated through an interactive cable network, when an error occurs in the security module program or a version update of the security module program is required.

A recent set-top box may include a Digital Video Recorder (DVR) function that may record a live program while watching another live program, as well as a function to simply process broadcasting data. Also, a function enabling a user to watch a program using a Personal Computer (PC) or another device through a home network may be provided.

In particular, DCAS may define an Authorized Service Domain (ASD) enabling broadcasting data, that may be stored in a set-top box or externally outputted through a home network, to be used in only a storage device managed by a broadcasting provider.

Accordingly, a set-top box is required to simultaneously record a plurality of programs. For this, a multi-stream encryption process is required in a mounted security module.

### SUMMARY OF THE INVENTION

According to an aspect of the present invention, there is provided a host device, including: a modulation unit to receive communication data via a multi-channel, demodulate and output a transport stream of the multi-channel; a security module to receive and descramble the transport stream outputted from the modulation unit, and encrypt the descrambled transport stream; and a Digital Video Recorder (DVR) unit to record the encrypted transport stream.

According to another aspect of the present invention, there is provided a multi-stream encryption apparatus, including: a multiplexing unit to multiplex a descrambled transport stream of a multi-channel into a multi-stream; a filter unit to filter a TS packet of the multiplexed multi-stream; an encryption unit to encrypt the multiplexed multi-stream; a demultiplexing unit to demultiplex the encrypted multi-stream based on the multi-channel; and a counter unit to generate a clock counter for compensating for a jitter of a Packet Clock Reference (PCR) with respect to the descrambled transport stream of the multi-channel.

According to still another aspect of the present invention, there is provided a multi-stream encryption method, including: multiplexing a transport stream corresponding to a multi-channel into a multi-stream through a multiplexing unit; filtering a TS packet of the multiplexed multi-stream; encrypting the multiplexed multi-stream; and demultiplexing the encrypted multi-stream based on the multi-channel.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration of a host device supporting a Digital Video Recorder (DVR) function in a Downloadable Conditional Access System (DCAS) according to an embodiment of the present invention;

FIG. 2 is a block diagram illustrating a configuration of a security module included in a host device of FIG. 1;

FIG. 3 is a block diagram illustrating a configuration of an Authorized Service Domain (ASD) encryption unit of a Transport Processor (TP) of FIG. 1;

FIG. 4 is a diagram illustrating a configuration of a Transport Stream (TS) packet of a multi-stream according to an embodiment of the present invention;

FIG. 5 is a block diagram illustrating a configuration of a multiplexing unit of FIG. 3;

FIG. 6 is a block diagram illustrating a configuration of a demultiplexing unit of FIG. 3;

FIG. 7 is a diagram illustrating a Packet Clock Reference (PCR) compensation operation according to an embodiment of the present invention; and

FIG. 8 is a flowchart illustrating a multi-stream encryption method according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures. When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

A ‘host device’ or ‘host’ may indicate a device such as a set-top box that may support a downloadable client in a Secure Micro (SM) based on a Downloadable Conditional Access System (DCAS) standard. Also, the ‘host device’ or ‘host’ may include a Data Over Cable Service Interface Specification/DOCSIS Set-top Gateway (DOCSIS/DSG) embedded Cable Modem (eCM), an SM driver, and a conditional access network handler to support the DCAS.

Also, an ‘SM client’ may include an Authorized Service Domain (ASD) client, a Certificate Authority (CA) client, and a Digital Rights Management (DRM) client.

Also, a DCAS protocol may be defined as a communication mechanism with respect to a standard and process of a message transmitted/received among a Certificate Authority (CA), an authentication server, and a security module.

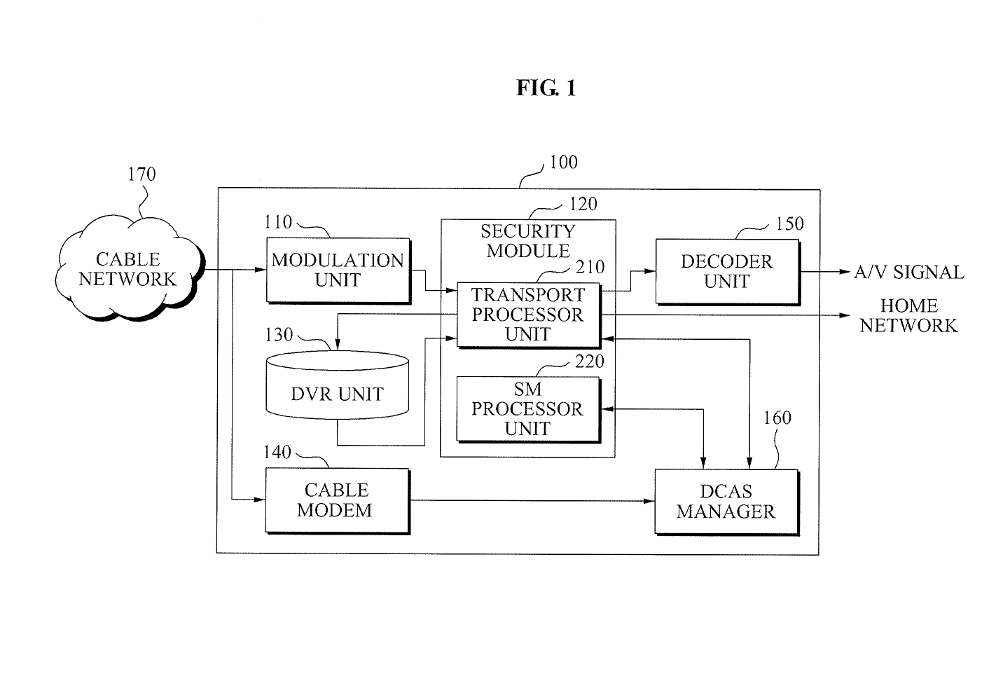

FIG. 1 is a block diagram illustrating a configuration of a host device 100 supporting a Digital Video Recorder (DVR) function in a DCAS according to an embodiment of the present invention.

The host device 100 may receive host authentication information from a CA (not shown) through a cable network 170, and verify validity of an SM program based on the received host authentication information. Also, the host device 100 may transmit a host state information message to an authentication server (not shown) of a headend system (not shown). Also, the host state information message may include host state information about validity verification information of the SM program. A security module 120 of the host device 100 may use a third CA as opposed to a cable service provider, to manage the authentication server of the headend system and information required for authentication and validity verification. Accordingly, the security module 120 of the host device 100 may provide the host device 100 with the SM program to protect a video and media technology connected to a Consumer Premise Equipment (CPE) (not shown).

Referring to FIG. 1, the host device 100 may include a modulation unit 110, the security module 120, and a DVR unit 130.

The modulation unit 110 may receive communication data via a multi-channel, demodulate and output a transport stream of the multi-channel. The modulation unit 110 may function for broadcasting channel tuning and Quadrature Amplitude Modulation (QAM) demodulation.

The security module 120 may receive and descramble the transport stream outputted from the modulation unit 110, and encrypt the descrambled transport stream.

The security module 120 may include an SM processor unit 220. The SM processor unit 220 may extract a Control Word (CW) and Copy Control Information (CCI) from the transport stream of the multi-channel through a Conditional Access (CA) client, and generate an encryption key from the extracted CCI through an Authorized Service Domain (ASD) client.

Also, the security module 120 may include a Transport Processor (TP) unit 210. The TP unit 210 may descramble the transport stream of the multi-channel using the CW, and encrypt the descrambled transport stream using the encryption key.

The DVR unit 130 may record the transport stream encrypted through the security module 120.

The host device 100 may further include a cable modem 140, a decoder unit 150, and a DCAS manager 160. The cable modem 140 may transmit/receive additional broadcasting data including a DCAS protocol-related message and an SM client. The decoder unit 150 may restore a compressed audio/video (A/V) signal. The DCAS manager 160 may control the above-described components of the host device 100 and routing of messages transmitted/received among the components.

The host device 100 may be operated as follows. When power is supplied to the host device 100, the security module 120 may perform a host authentication process. When the host authentication process is appropriately completed, host state information of the SM client may be verified. The host state information may be stored in the security module 120.

When the SM client is required to be downloaded, the download of an SM program is requested to the authentication server, and the SM program may be received through the cable modem 140. The received SM program may be stored and operated in the security module 120.

The headend system connected through the cable network 170 may include the authentication server. The authentication server may receive a validity verification message including validity verification information about the host device 100 from the CA. Also, the authentication server may transmit, to the security module 120, a host authentication message including the host authentication information corresponding to the validity verification information about the host device 100.

The authentication server may transmit the host authentication information and information for generating a session key required for the authentication, to the security module 120 via a Cable Modem Termination System (CMTS).

Also, all key information generated during a mutual authentication process may be managed by a key management server of the headend system.

Accordingly, the security module 120 that downloads or updates the SM client may obtain an authority to a broadcasting signal, and provide a subscriber with a fee-based broadcasting service through the CPE. In this instance, the broadcasting signal may be scrambled and transmitted.

As described above, an SM client operated in the SM processor unit 220 may include an ASD client, a CA client, and a DRM client.

The CA client operated in the SM processor unit 220 may provide the TP unit 210 with initial information, a scrambling scheme, and key information required to descramble the transport stream of the multi-channel. Also, the CA client may enable the TP unit 210 to descramble the transport stream.

The ASD client operated in the SM processor unit 220 may transmit key information to the TP unit 210 to encrypt and record the descrambled transport stream. The key information may be used for encryption. Subsequently, the TP unit 210 may encrypt the transport stream using the encryption key received from the ASD client.

The transport stream corresponding to the multi-channel may be encrypted and stored in the DVR unit 130 by the host device 100.

The ASD client may transmit decryption key information to the TP unit 210 to replay the stored transport stream. Also, the TP unit 210 may decrypt the encrypted transport stream, outputted from the DVR unit 130, using the received decryption key information. The decoder unit 150 may restore the decrypted transport stream as an A/V signal. Hereinafter, a configuration to encrypt a transport stream of a multi-channel is described in detail.

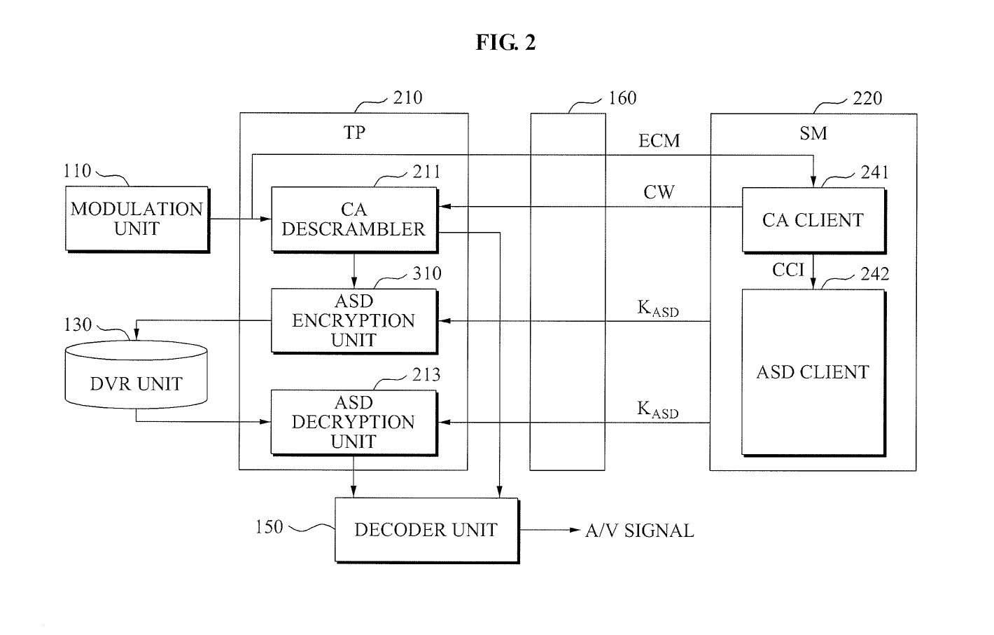

FIG. 2 is a block diagram illustrating a configuration of the security module included in the host device of FIG. 1.

Referring to FIG. 2, the security module 120 may include the SM processing unit 210. The SM processing unit 210 may extract a CW and CCI from a transport stream of a multi-channel through a CA client 241, and generate an encryption key K_{ASD} from the extracted CCI through an ASD client 242 from among SM clients.

Also, the security module 120 may include a TP unit 210. The TP unit 210 may descramble the transport stream of the multi-channel using the CW received from the CA client 241, and encrypt the descrambled transport stream using the encryption key K_{ASD} received from the ASD client 242.

The TP unit 210 may include a CA descrambler 211 that descrambles the transport stream of the multi-channel using the CW received from the CA client 241.

Also, the TP unit 210 may include an ASD encryption unit 310 that encrypts the descrambled transport stream, received from the CA descrambler 211, using the encryption key K_{ASD} received from the ASD client 242.

Also, the TP unit 210 may include an ASD decryption unit 213 that decrypts the encrypted transport stream, outputted from the DVR unit 130, using a decryption key K_{ASD} received from the ASD client 242.

Specifically, the transport stream, outputted from the modulation unit 110, may be inputted to the TP unit 210. The CA descrambler 211 of the TP unit 210 may filter an Entitlement Control Message (ECM) packet associated with a viewing entitlement from the transport stream received form the modulation unit 110.

The ECM may be transmitted to the CA client 241 of the SM processor unit 220.

All messages transmitted/received between the TP unit 210 and the SM processor unit 220 may be routed by the DCAS manager 160.

The CA client 241 may extract the CW and the CCI from the ECM received from the CA descrambler 211, transmit the CW to the CA descrambler 211, and transmit the CCI to the ASD client 242.

Also, the CA descrambler 211 may descramble the transport stream, inputted from the modulation unit 110, using the CW.

The descrambled transport stream may be restored in the decoder unit 150, and be inputted to the ASD encryption unit 310 for recording.

Also, the ASD client 242 receiving the CCI from the CA client 241 may transmit the encryption key K_{ASD} to the ASD encryption unit 310 to store the transport stream, that is, to record a program stream according to a copy protection policy of the CCI.

The ASD encryption unit 310 may encrypt the transport stream, received from the CA descrambler 211, using the encryption key K_{ASD} received from the ASD client 242, and store the encrypted transport stream in the DVR unit 130.

The transport stream stored in the DVR unit 130 may be outputted to the ASD decryption unit 213 to be replayed. The ASD decryption unit 213 may receive the decryption key K_{ASD} from the ASD client 242 to decrypt the transport stream received from the DVR unit 130.

The ASD decryption unit 213 may decrypt the encrypted transport stream using the decryption key K_{ASD} received from the ASD client 242, and output the decrypted transport stream to the decoder unit 150. The decoder unit 150 may restore the decrypted transport stream and output an A/V signal.

Hereinafter, a configuration to encrypt a transport stream of a multichannel is described in detail.

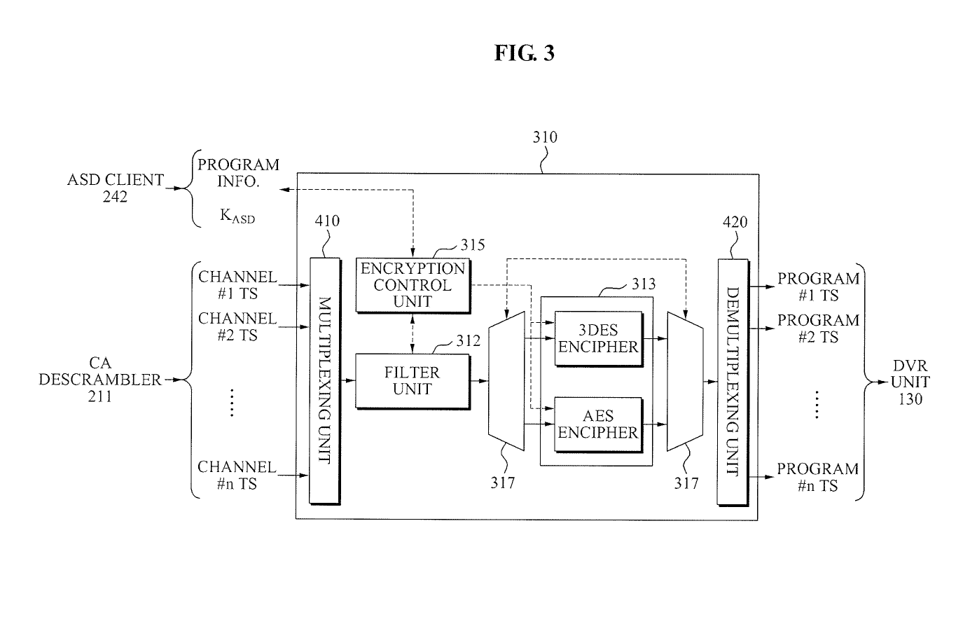

FIG. 3 is a block diagram illustrating a configuration of the ASD encryption unit 310 of the TP unit 210 of FIG. 1.

Referring to FIG. 3, the ASD encryption unit 310 of the TP unit 210 may include a multiplexing unit 410, a filter unit 312, an encryption unit 313, and a demultiplexing unit 420.

The multiplexing unit 410 may multiplex the descrambled transport stream of the multi-channel into a multi-stream. The filter unit 312 may filter a Transport Stream (TS) packet of the multiplexed multi-stream. The TS packet may include a Program Specific Information (PSI) table. The encryption unit 313 may encrypt the filtered multi-stream.

The encryption unit 313 may include a triple Data Encryption Standard (3DES) encipher supporting a triple-DES encryption and an Advanced Encryption Standard (AES) encipher supporting an AES encryption. An encryption scheme for ASD may be selected for each broadcasting provider through the 3DES encipher and the AES encipher. For this, the ASD encryption unit 310 may further include switching units 317 to control an input/output of a corresponding encipher.

The demultiplexing unit 420 may demultiplex the encrypted multi-stream corresponding to the multi-channel.

The ASD encryption unit 310 may further include an encryption control unit 315 and a counter unit (not shown). The encryption control unit 315 may receive an encryption key or information corresponding to the transport stream of the multi-channel from the ASD client, and control the encryption of the multiplexed multi-stream. Also, the encryption control unit 315 may communicate with the ASD client 242. The counter unit may generate a clock counter to compensate for a jitter of a Packet Clock Reference (PCR) corresponding to the descrambled transport stream.

The counter unit may generate a 27 MHz Moving Picture Experts Group (MPEG) clock counter to compensate for a timing jitter due to the multiplexing.

Also, the filter unit 312 may filter the multiplexed multi-stream based on program information corresponding to the transport stream of the multi-channel, and output the TS packet.

The multiplexed multi-stream may include pre-header information including local Transport Stream Identification information (TSID) to identify the transport stream of the multi-channel, and local time information to compensate for the jitter of the PCR. The encryption unit 313 may encrypt the filtered multi-stream using the encryption key based on the local TSID and Program Identification information (PID).

The demultiplexing unit 420 may compensate for the jitter of the PCR based on the local time information, remove the pre-header information of the encrypted multi-stream where the jitter of the PCR is compensated for, and demultiplex the encrypted multi-stream based on the multi-channel using the local TSID.

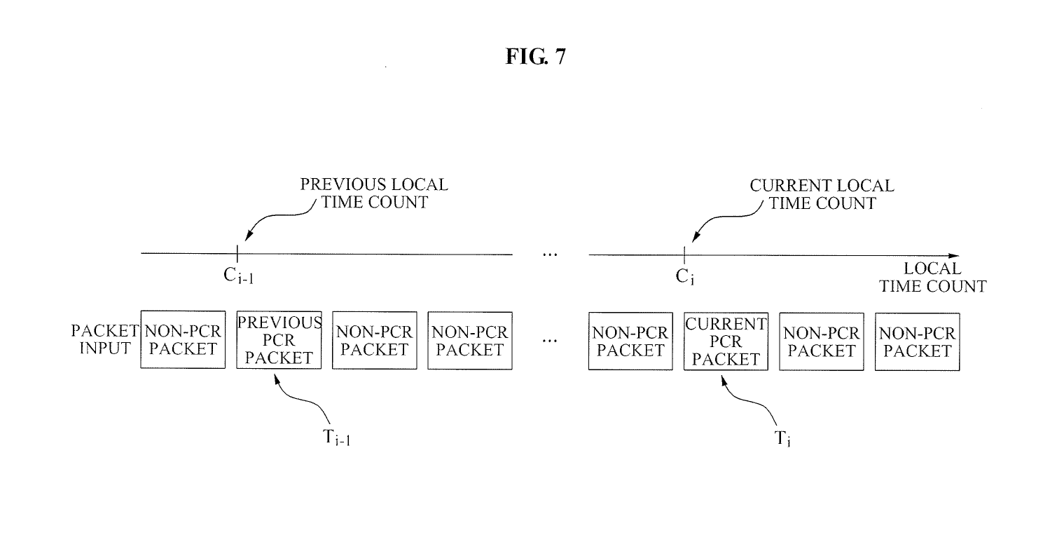

Also, the demultiplexing unit 420 may compare local time difference information with clock counter difference information to compensate for the jitter of the PCR, which is described in greater detail with reference to FIG. 7. The local time difference information may be calculated from first local time information of a first TS packet and second local time information of a second TS packet, and the clock counter difference information may be calculated from first clock counter information of the first TS packet and second clock counter information of the second TS packet. The first clock counter information and the second clock counter information may be received from the counter unit.

Hereinafter, an operation of the ASD encryption unit 310 is described in detail.

When the ASD client 242 of the SM processor unit 220 transmits an initial message about an ASD encryption unit 310 to the encryption control unit 315, the encryption control unit 315 may analyze the initial message, determine which encipher of the encryption unit 313 is used, and initialize the determined encipher.

The encryption control unit 315 may receive, from the ASD client 242, an encryption key K_{ASD} and program information about a program to record in each channel of the multi-channel. The program information may include local TSID, Program Map Table (PMT), PID, and A/V PIDs.

The encryption control unit 315 may transmit the program information for each channel, received from the ASD client 242, to the filter unit 312, and set the filter unit 312.

The multiplexing unit 410 may receive the descrambled transport stream of the multi-channel from the CA descrambler 211, multiplex the descrambled transport stream into a single stream, and output the multiplexed multi-stream. While multiplexing, the transport stream for each channel may be differentiated, and the jitter of the PCR may be compensated.

For this, the multiplexing unit 410 may add pre-header information with respect to the TS packet of the transport stream. The pre-header information may include local TSID to identify the transport stream of the multi-channel, and local time information to compensate for the jitter of the PCR, as described above.

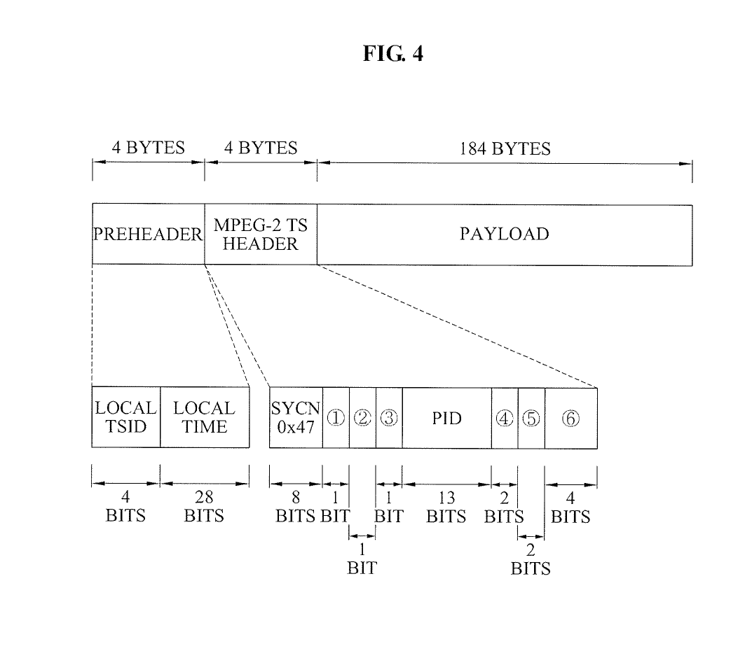

Hereinafter, the pre-header information to be inserted in the TS packet is described in detail with reference to FIG. 4.

FIG. 4 is a diagram illustrating a configuration of a TS packet of a multi-stream according to an embodiment of the present invention. Four-byte pre-header information including four-bit local TSID and 28-bit local time information is illustrated as an example.

Referring to FIG. 4, the pre-header information inserted in the TS packet may include stream identification information, which is referred to as ‘local TSID’, and local time information. The local TSID may be used to determine which channel each TS packet is included in, even though a transport stream of a multi-channel is multiplexed into a single multi-stream.

The local TSID and PID of a TS head may be used for filtering in the filter unit 312, and for demultiplexing in a demultiplexer 306 demultiplexing unit 420.

Also, the local time information may be used when the demultiplexing unit 420 compensates for a jitter of a PCR.

Referring again to FIG. 3, the filter unit 312 may perform a setting operation based on program information from the encryption control unit 315. The program information may be used to record each channel of the multi-channel. Also, the filter unit 312 may filter the multi-stream based on program information corresponding to the transport stream for each channel of the multi-channel.

The filter unit 312 may differentiate each channel of the multi-channel using the local TSID included in the pre-header information. Also, the filter unit 312 may output a packet where a PID of a differentiated channel is ‘0’, that is, a packet including a Program Associate Table (PAT), a packet including a PMT PID, or packets including A/V PIDs.

The multi-stream filtered by the filter unit 312 may be inputted to a 3DES encipher or an AES encipher of the encryption unit 313 through a path set by the switching unit 317. The 3DES encipher or the AES encipher may encrypt packets of the filtered multi-stream using the local TSID and the PID of the TS header.

In this instance, the encryption unit 313 may perform encryption with respect to only the packets including A/V PIDs. An encryption key value used for the encryption may vary for each of the channels of the multi-channel.

The encrypted multi-stream outputted through the encryption unit 313 may be outputted to the demultiplexing unit 420 through the switching unit 317. The demultiplexing unit 420 may demultiplex each of the packets of the encrypted multi-stream using the pre-header information.

When performing demultiplexing, the demultiplexing unit 420 may retrieve the TS packet including the PCR using the local time information included in the pre-header information, and compensate for the jitter of the PCR. Subsequently, the demultiplexing unit 420 may output the multi-stream where the pre-header information is removed from the encrypted multi-stream.

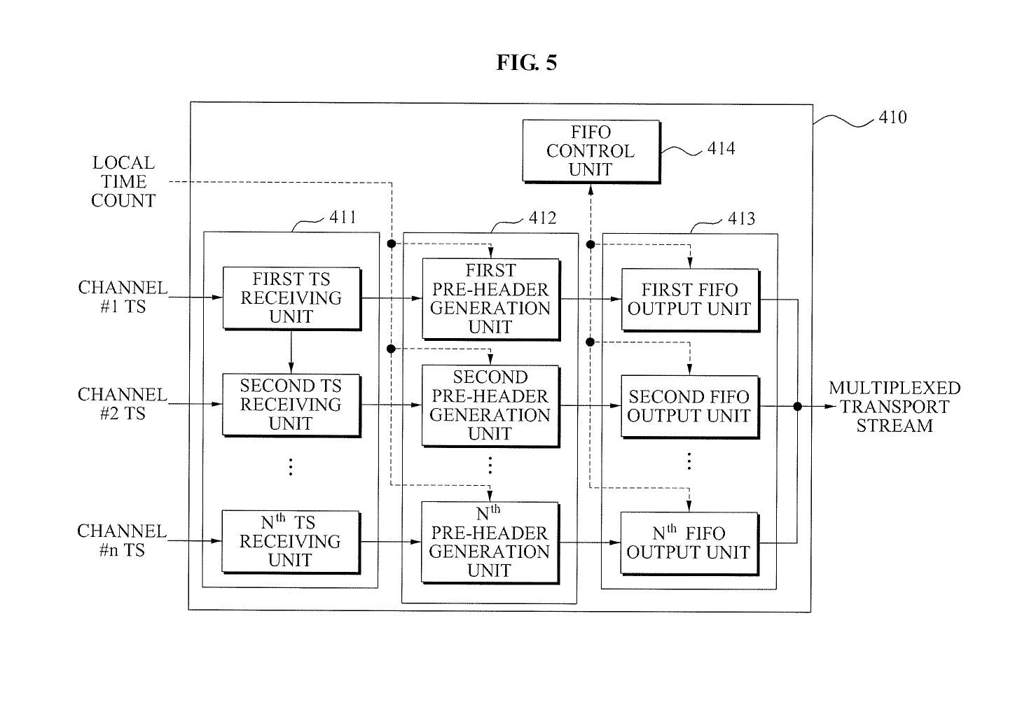

FIG. 5 is a block diagram illustrating a configuration of the multiplexing unit 410 of FIG. 3.

Referring to FIG. 5, the multiplexing unit 410 may include a TS receiving unit 411, a pre-header generation unit 412, and a First-In First-Out (FIFO) output unit 413. The FIFO output unit 413 may be referred to as ‘output FIFO’.

The TS receiving unit 411 may receive the descrambled transport stream of the multi-channel for each channel of the multi-channel.

A first TS receiving unit may receive a descrambled transport stream of a channel #1. A second TS receiving unit may receive a descrambled transport stream of a channel #2, and an n^{th} TS receiving unit may receive a descrambled transport stream of a channel #n.

The pre-header generation unit 412 may generate pre-header information, and insert the pre-header information in the descrambled transport stream, received from the TS receiving unit 411, and output the descrambled transport stream.

A first pre-header generation unit may insert the pre-header information in the descrambled transport stream, received from the first TS receiving unit, of the channel #1. A second pre-header generation unit may insert the pre-header information in the descrambled transport stream, received from the second TS receiving unit, of the channel #2. Also, an n^{th} pre-header generation unit may insert the pre-header information in the descrambled transport stream, received from the n^{th} TS receiving unit, of the channel #n.

The descrambled transport stream including the pre-header information, outputted from the pre-header generation unit 412, may be outputted in a form of a 192 byte packet, since four-byte pre-header information is added as described in FIG. 4. Also, local time information of the pre-header information may receive a current clock counter value received from the counter unit of FIG. 3.

The output FIFO 413 may receive the descrambled transport stream for each of the channels, outputted from the pre-header generation unit 412, output the received transport stream in a predetermined order, and multiplex the transport stream into the multi-stream.

A first output FIFO may receive the descrambled transport stream, outputted from the first pre-header generation unit, of the channel #1. A second output FIFO may receive the descrambled transport stream, outputted from the second pre-header generation unit, of the channel #2. Also, an n^{th} output FIFO may receive the descrambled transport stream, outputted from the n^{th} pre-header generation unit, of the channel #n.

The multiplexing unit 410 may further include a FIFO control unit 414. The FIFO control unit 414 may prevent packets, outputted from the output FIFO 413, from colliding each other.

The output FIFO 413 may transmit a number of bytes of currently stored data to the FIFO control unit 414 at every clock. Referring again to FIG. 4, the FIFO control unit 414 may transmit a control signal to the first output FIFO storing 192 bytes. The FIFO control unit 414 may ascertain whether a number of bytes stored in the second output FIFO is equal to or greater than 192 after 192 clocks, and transmit a control signal to the second output FIFO. Accordingly, the packets outputted from each of the output FIFOs may be prevented from colliding.

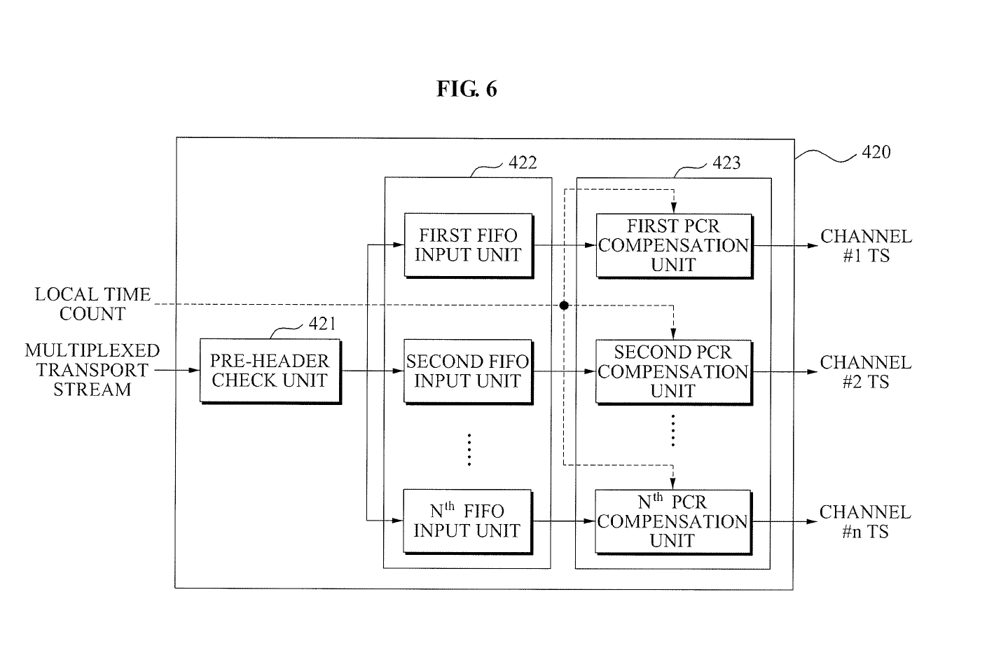

FIG. 6 is a block diagram illustrating a configuration of the demultiplexing unit 420 of FIG. 3.

Referring to FIG. 6, the demultiplexing unit 420 may include a pre-header check unit 421, a FIFO input unit 422, and a PCR compensation unit 423.

The pre-header check unit 421 may analyze local TSID. The local TSID may be used to identify the transport stream of the multi-channel from pre-header information included in the encrypted multi-stream.

The FIFO input unit 422 may demultiplex the encrypted multi-stream based on the multi-channel using the analyzed local TSID.

That is, the FIFO input unit 422 may retrieve a start of a TS packet including the pre-header information from the encrypted multi-stream, and store a start byte of the TS packet in a first FIFO input unit. When 192 TS packets including a pre-header are stored in the first FIFO input unit, the 192 TS packets may be outputted in a data block form through synchronization with an operation clock. An identical process may be performed with respect to a second FIFO input unit and an n^{th} FIFO input unit.

The PCR compensation unit 423 may compensate for the jitter of the PCR based on the pre-header information and a clock counter. Hereinafter, a PCR compensation operation performed by the PCR compensation unit 423 is described in detail.

FIG. 7 is a diagram illustrating a PCR compensation operation according to an embodiment of the present invention.

A demultiplexing unit 420 may compare local time difference information with clock counter difference information to compensate for a jitter of a PCR. The local time difference information may be calculated from first local time information of a first TS packet, that is, a previous PCR packet, and second local time information of a second TS packet, that is, a current PCR packet. The clock counter difference information may be calculated from first clock counter information of the first TS packet and second clock counter information of the second TS packet. In this instance, the first clock counter information and the second clock counter information may be received from a counter unit.

That is, when the first TS packet including the PCR is retrieved, the demultiplexing unit 420 may record the first local time information Tᵢ₋₁ and the first clock counter information Cᵢ₋₁. Subsequently, the demultiplexing unit 420 may determine whether to compensate for the jitter of the PCR based on a difference between (Cᵢ-Cᵢ₋₁) and (Tᵢ-Tᵢ₋₁) using the second local time information Tᵢ and the second clock counter information Cᵢ from the subsequently retrieved second TS packet including the PCR.

When the difference between (C₁-Cᵢ₋₁) and (Tᵢ-Tᵢ₋₁) is not ‘0’, the demultiplexing unit 420 may determine that the jitter occurs, and compensate for the PCR by the difference between (Cᵢ-Cᵢ₋₁) and (Tᵢ-Tᵢ₋₁).

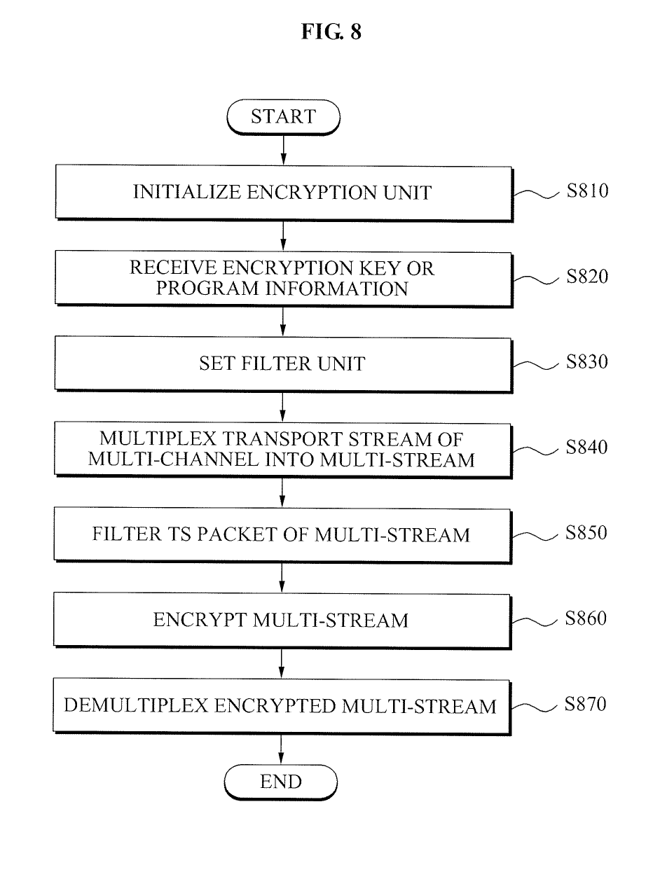

FIG. 8 is a flowchart illustrating a multi-stream encryption method according to an embodiment of the present invention.

Referring to FIG. 8, in operation S810, the multi-stream encryption method may receive an initial message from an ASD client, and initialize an encryption unit.

That is, in operation S810, when the ASD client 242 transmits an initial message about an ASD encryption unit 310 to an encryption control unit 315, the encryption control unit 315 analyzes the initial message, determines which encipher of an encryption unit 313 is used, and initializes the determined encipher.

In operation S820, the multi-stream encryption method may receive an encryption key and program information about a transport stream corresponding to a multi-channel from the ASD client.

That is, in operation S820, the encryption control unit 315 may receive, from the ASD client 242, an encryption key K_{ASD} and program information about a program to record in each channel of the multi-channel. The program information may include local TSID, PMT PID, and A/V PIDs.

In operation S830, the multi-stream encryption method may set a filter unit using the program information.

That is, in operation S830, the encryption control unit 315 may transmit the program information for each channel, received from the ASD client 242, to the filter unit 312, and set the filter unit 312.

In operation S840, the multi-stream encryption method may multiplex the transport stream corresponding to the multi-channel into a multi-stream through a multiplexing unit. In operation S850, the multi-stream encryption method may filter a TS packet of the multiplexed multi-stream.

In operation S860, the multi-stream encryption method may encrypt the multiplexed multi-stream. In operation S870, the multi-stream encryption method may demultiplex the encrypted multi-stream corresponding to the multi-channel.

The multi-stream encryption method according to the above-described example embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

According to an embodiment of the present invention, a host device supporting a DCAS may record a plurality of programs received from a multi-channel.

Also, according to an embodiment of the present invention, a multi-stream encryption method and apparatus may multiplex a descrambled transport stream of a multi-channel into a multi-stream, encrypt the multiplexed multi-stream, and demultiplex the encrypted multi-stream corresponding to the multi-channel.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A host device, comprising:
a modulation unit to receive communication data via a multi-channel, and to demodulate and output a transport stream of the multi-channel;
a security module to receive and descramble the transport stream outputted from the modulation unit, and to encrypt the descrambled transport stream; and
a Digital Video Recorder (DVR) unit to record the encrypted transport stream.

2. The host device of claim 1, wherein the security module comprises:
a Secure Micro (SM) processor unit to extract a Control Word (CW) and Copy Control Information (CCI) from the transport stream of the multi-channel through a Conditional Access (CA) client, and to generate an encryption key from the extracted CCI through an Authorized Service Domain (ASD) client; and
a transport processor unit to descramble the transport stream of the multi-channel using the CW, and to encrypt the descrambled transport stream using the encryption key.

3. The host device of claim 2, wherein the transport processor unit comprises:
a CA descrambler to descramble the transport stream of the multi-channel using the CW; and
an ASD encryption unit to encrypt the descrambled transport stream, received from the CA descrambler, using the encryption key.

4. The host device of claim 2, wherein the transport processor unit comprises:
an ASD decryption unit to decrypt the encrypted transport stream, outputted from the DVR unit, using a decryption key received from the ASD client.

5. The host device of claim 3, wherein the ASD encryption unit comprises:
a multiplexing unit to multiplex the descrambled transport stream of the multi-channel into a multi-stream;
a filter unit to filter a Transport Stream (TS) packet of the multiplexed multi-stream;
an encryption unit to encrypt the filtered multi-stream; and
a demultiplexing unit to demultiplex the encrypted multi-stream based on the multi-channel.

6. The host device of claim 5, wherein the ASD encryption unit further comprises:
an encryption control unit to receive the encryption key or information corresponding to the transport stream of the multi-channel from the ASD client, and to control the encryption of the multiplexed multi-stream; and
a counter unit to generate a clock counter for compensating for a jitter of a Packet Clock Reference (PCR) corresponding to the descrambled transport stream.

7. The host device of claim 6, wherein the filter unit filters the multiplexed multi-stream based on program information corresponding to the transport stream of the multi-channel, received from the encryption control unit, to output the TS packet.

8. The host device of claim 6, wherein the multiplexed multi-stream includes pre-header information including local Transport Stream Identification information (TSID) to identify the transport stream of the multi-channel, and local time information to compensate for the jitter of the PCR.

9. The host device of claim 8, wherein the encryption unit encrypts the filtered multi-stream using the encryption key based on the local TSID and Program Identification information (PID).

10. The host device of claim 8, wherein the demultiplexing unit compensates for the jitter of the PCR based on the local time information, removes the pre-header information of the encrypted multi-stream where the jitter of the PCR is compensated for, and demultiplexes the encrypted multi-stream based on the multi-channel using the local TSID.

11. The host device of claim 8, wherein the demultiplexing unit compares local time difference information with clock counter difference information to compensate for the jitter of the PCR, the local time difference information being calculated from first local time information of a first TS packet and second local time information of a second TS packet, the clock counter difference information being calculated from first clock counter information of the first TS packet and second clock counter information of the second TS packet, and the first clock counter information and the second clock counter information being received from the counter unit.

12. The host device of claim 6, wherein the multiplexing unit comprises:
a TS receiving unit to receive the descrambled transport stream of the multi-channel for each channel;
a pre-header generation unit to generate pre-header information, to insert the pre-header information in the descrambled transport stream, received from the TS receiving unit, and to output the descrambled transport stream; and
a First-In First-Out (FIFO) output unit to receive the descrambled transport stream for each of the channels, outputted from the pre-header generation unit, to output the received transport stream in a predetermined order, and to multiplex the transport stream into the multi-stream.

13. The host device of claim 6, wherein the demultiplexing unit comprises:
a pre-header check unit to analyze local TSID used to identify the transport stream of the multi-channel from pre-header information included in the encrypted multi-stream;
a FIFO input unit to demultiplex the encrypted multi-stream based on the multi-channel using the analyzed local TSID; and
a PCR compensation unit to compensate for the jitter of the PCR based on the pre-header information and the clock counter.

14. A multi-stream encryption apparatus, comprising:
a multiplexing unit to multiplex a descrambled transport stream of a multi-channel into a multi-stream;
a filter unit to filter a TS packet of the multiplexed multi-stream;
an encryption unit to encrypt the multiplexed multi-stream;
a demultiplexing unit to demultiplex the encrypted multi-stream based on the multi-channel; and
a counter unit to generate a clock counter for compensating for a jitter of a PCR with respect to the descrambled transport stream of the multi-channel.

15. The multi-stream encryption apparatus of claim 14, further comprising:
an encryption control unit to receive an encryption key or information corresponding to the transport stream of the multi-channel from an ASD client, and to control the encryption of the multiplexed multi-stream.

16. A multi-stream encryption method, comprising:
multiplexing a transport stream corresponding to a multi-channel into a multi-stream through a multiplexing unit;
filtering a TS packet of the multiplexed multi-stream;
encrypting the multiplexed multi-stream; and
demultiplexing the encrypted multi-stream based on the multi-channel.

17. The multi-stream encryption method of claim 16, wherein the multiplexing comprises:
receiving an initial message from an ASD client and initializing an encryption unit;
receiving an encryption key or program information about the transport stream corresponding to the multi-channel from the ASD client; and
setting a filter unit based on the program information.
